(19) United States
(12) Patent Application Publication
(10) Pub. No.: US 2011/0131523 A1
(43) Pub. Date: Jun. 2, 2011

(54) GROUPING OF WINDOWS BASED ON USER-DEFINED CONTEXTS

(75) Inventors: Cristina L. Grant, Cary, NC (US); Renee S. LaMar, Tucson, AZ (US); Fang Lu, Billerica, MA (US); Bhargav R. Perepa, Leesburg, VA (US); Sujatha Perepa, Leesburg, VA (US)

(73) Assignee: INTERNATIONAL BUSINESS MACHINES CORPORATION, Armonk, NY (US)

(21) Appl. No.: 12/627,401

(22) Filed: Nov. 30, 2009

(51) Int. Cl. G06F 3/048

(52) U.S. Cl. 715/777; 715/781

(57) ABSTRACT

The grouping of windows based on user-defined contexts is disclosed. A computer-implemented method of grouping windows based on user-defined contexts in accordance with an embodiment includes: assigning a user-defined context to a plurality of elements in an environment; grouping the plurality of elements into at least one group based on the user-defined context assigned to each of the plurality of elements; and displaying a context window tab corresponding to each group of elements.

### TECHNICAL FIELD

The disclosure relates to the grouping of windows based on user-defined contexts.

### BACKGROUND ART

When working in an environment, such as an Integrated Development Environment (IDE) or web browser environment, a plurality of windows are often opened and displayed to a user. Depending on the environment, the windows may comprise, for example, elements such as programs, files, web pages, etc. Often, users may have a large number of windows open at any given time, making it difficult to navigate through the windows in an efficient and organized manner.

### SUMMARY OF THE INVENTION

Aspects of the invention are directed to the grouping of windows based on user-defined contexts.

A first aspect of the invention provides a computer-implemented method of grouping windows based on user-defined contexts, the method comprising: assigning a user-defined context to a plurality of elements in an environment; grouping the plurality of elements into at least one group based on the user-defined context assigned to each of the plurality of elements; and displaying a context window tab corresponding to each group of elements.

A second aspect of the invention provides a computer system comprising: a component configured to group windows based on user-defined contexts by: assigning a user-defined context to a plurality of elements in an environment;

grouping the plurality of elements into at least one group based on the user-defined context assigned to each of the plurality of elements; and displaying a context window tab corresponding to each group of elements.

A third aspect of the invention provides a computer program comprising program code embodied in at least one computer-readable medium, which when executed, enables a computer system to implement a method of grouping windows based on user-defined contexts, the method comprising: assigning a user-defined context to a plurality of elements in an environment; grouping the plurality of elements into at least one group based on the user-defined context assigned to each of the plurality of elements; and displaying a context window tab corresponding to each group of elements.

A fourth aspect of the invention provides a method of generating a computer system for grouping windows based on user-defined contexts, the method comprising:

providing a computer system operable to: assign a user-defined context to a plurality of elements in an environment; group the plurality of elements into at least one group based on the user-defined context assigned to each of the plurality of elements; and display a context window tab corresponding to each group of elements.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 depicts a user interface (UI) of an Integrated Development Environment (IDE) and user-defined contexts associated with a plurality of files according to an embodiment.

FIG. 2 depicts the user selection of a “group by context” function in the IDE UI of FIG. 1 according to an embodiment.

FIG. 3 depicts a context window tab according to an embodiment.

FIG. 4 depicts a plurality of context window tabs according to an embodiment.

FIG. 5 depicts a web browser environment and user-defined contexts associated with a plurality of URLs (Uniform Resource Locators) according to an embodiment.

FIG. 6 depicts the user selection of a “group by context” function in the web browser environment of FIG. 5 according to an embodiment.

FIG. 7 depicts a context window tab according to an embodiment.

FIG. 8 depicts a plurality of context window tabs according to an embodiment.

FIG. 9 depicts a flow diagram of a process for using context-based functionality according to an environment.

FIG. 10 depicts a “select existing context” dialog box according to an embodiment.

FIG. 11 depicts a “create new context” dialog box according to an embodiment.

FIG. 12 depicts a context list according to an embodiment.

FIG. 13 depicts metadata associated with a user-defined context according to an embodiment.

FIG. 14 depicts identifying information associated with a user-defined context according to an embodiment.

FIG. 15 depicts an illustrative environment for grouping windows based on user-defined contexts according to an embodiment.

The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention are directed to the grouping of windows based on user-defined contexts. As used herein, unless otherwise noted, the term “set” means one or more (i.e., at least one) and the phrase “any solution” means any now known or later developed solution.

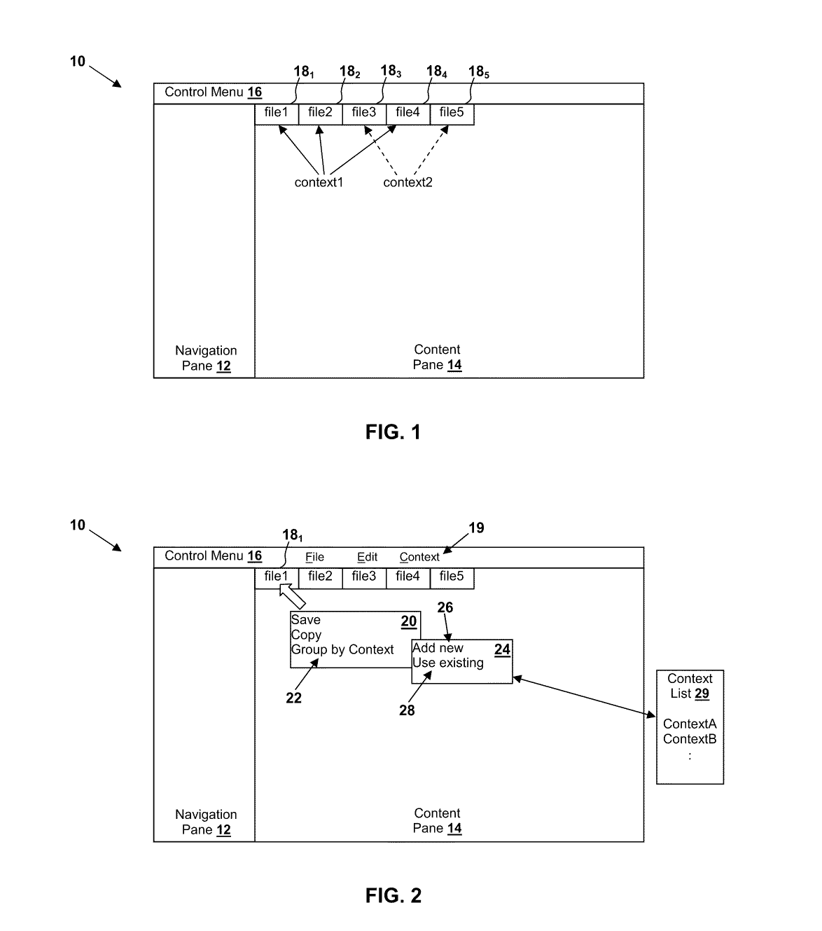

Turning to the drawings, FIG. 1 shows an illustrative user interface (UI) 10 of an Integrated Development Environment (IDE). UI 10 includes a navigation pane 12 for displaying a list of files, a content pane 14 for displaying a window containing the contents of a file, and a control menu 16.

In this example, a user searches for a specific class in a programming language in order to verify different ways that the class may have been implemented/coded. To this extent, the user performs a file search for the class and opens files containing this class. This class comprises a first context, referred to as “context1” by the user. Initially, as depicted in FIG. 1, the user opens two files (file1, file2) associated with context1 during the search. The windows displaying the contents of the opened files (file1, file2) are organized in the content pane 14 using window tabs 18₁ and 18₂. Although not shown for clarity, the window displaying the content of the file associated with a currently active (e.g., selected, most recently opened, etc.) window tab 18 is displayed in the content pane 12.

In the process of searching for the class (i.e., context1), the user discovers additional content relevant to the class. The additional relevant content comprises a second context and is referred to as “context2” by the user. After opening a file (file3) associated with context2 the user continues the search for both context1 and context2. This results in the user opening an additional file (file4) associated with context1 and an additional file (file5) associated with context2. As depicted in FIG. 1, there are now five window tabs 18 (18₁-18₅) displayed in the content pane 12, corresponding to either context1 or context2. The window tabs 18 are displayed in sequential order based on the order in which the files were opened by the user.

Each window tab 18 displays the name of a corresponding file (file1-file5) that has been opened, but does not provide any indication of the context (e.g., context1, context2) that the user has associated with the file. As such, to track the context associated with a given file, the user has to select the window tab 18 corresponding to the file to display the contents of the file in the content pane 12.

In accordance with an embodiment, UI 10 includes an additional user functionality called “group by context,” which allows the user to organize window tabs associated with open files according to user-defined contexts. The “group by context” function can be selected, for example, by right clicking on a selected window tab 18, via a menu item 19 (e.g., “Context”) in the control menu 16 (see FIGS. 2-4), via a keyboard shortcut, etc. In the above and following descriptions, although various types of selecting techniques may be used and described in the embodiments, it should be clear that some/all of the above-described selecting techniques, as well as any other suitable now known and/or later developed selecting techniques, may be used in the practice of the embodiments.

As depicted in FIG. 2, the user has selected the “group by context” function by, for example, right clicking on one of the window tabs 18 (e.g., window tab 18₁ associated with file1). In response, a contextual menu 20 is displayed to the user. In addition to the functions (if any) typically provided in a contextual menu (e.g., save, copy, cut, paste, etc.), the user is presented with the menu item “group by context” 22. Selection of the “group by context” menu item 22 provides the user with several options, which may be presented in a pop-out window 24 or the like, by which the user can define the context that is to be assigned to a corresponding file. As shown in FIG. 2, the options may include “add new” 26, which allows the user to define a new context, and “use existing” 28, which allows the user to view and select the context from one or more context lists previously defined by the user.

An example of a context list 29 containing contexts previously defined by the user is depicted in FIGS. 2-4. The context list 29 is displayed to the user when the “use existing” option 28 is selected, and may, depending upon the embodiment, be displayed to the user when the “add new” option 26 is selected. The context list 29 may also be accessed and displayed at any time via the context menu item 19 in the control menu 16.

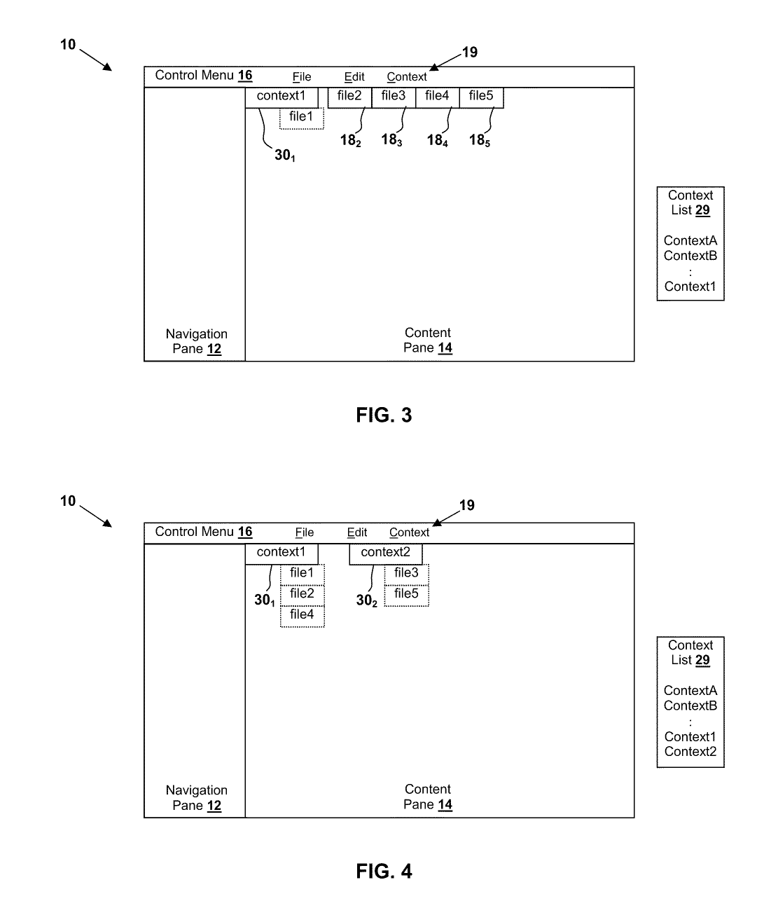

In this example, the user assigns a new context to file1, namely context1, using the “add new” option 26. The newly added context (context1) is appended to the context list 29 containing contexts previously defined by the user (see FIG. 3). Once added, the new context (context1) is available to the user via the “use existing” context menu option 28.

Continuing with the above example, as shown in FIG. 3, a context window tab 30₁, labeled “context1,” is displayed in the content pane 14, while the window tab 18₁ associated with file1 is no longer displayed. However, as depicted in phantom, file1 is now associated with the context1 window tab 30₁. The newly added context (context1) is now listed in the context list 29 containing the contexts previously defined by the user.

The user continues the above process and selects the window tabs 18 associated with the remaining files (file2-file5), in any desired order, and assigns an existing context (e.g., context1) from the context list 29 or a new context (e.g., context2) to each of the files. As a result, UI 10 now appears as shown in FIG. 4, where the context window tabs 30₁, 30₂, labeled “context1” and “context2,” respectively, are displayed in the content pane 14. At this point, the files (file1, file2, file4) are associated with the context1 window tab 30₁, while the files (file3, file5) are associated with the context2 window tab 30₂. The contexts (context1, context2) are listed in the context list 29 along with any other contexts previously defined by the user.

Each file may be assigned a plurality of different contexts. For example, if a file has been assigned to both context1 and context2, the file will be displayed under both the context1 window tab 30₁ and the context2 window tab 30₂ in FIG. 4.

In some environments, it may be possible to simultaneously select a plurality of the window tabs 18. In such a case, the above process can be used to assign the same new or existing user-defined context to a selected plurality of files at the same time.

In an embodiment, the files associated with each context window tab 30 are listed from top down in the order in which they were originally opened by the user. Other listing orders are also possible. For example, the files can be listed in alphabetical order, in the order in which context was assigned, etc. Further, although the window tabs 18 associated with the files are no longer visible in the content pane 14, in another embodiment, the window tabs 18 may be displayed in conjunction with the context window tabs 30. Further, in an embodiment, the listing order of the context window tabs 30 can be changed using, for example, a select and drag operation and/or the like.

The files associated with a context window tab 30 can be selectively displayed (e.g., as drop-down tabs, a file list, etc.) to a user. For example, the files associated with a given context window tab 30 can be displayed in response to a user selection of the context window tab 30. A particular file associated with the selected context window tab 30 can then be selected by the user for display in the content pane 14. To this extent, as depicted in phantom in FIG. 4, any of the files (file1, file2, file4) associated with context1 can be accessed and selected via the context1 window tab 30₁, while any of the files (file3, file5), associated with context2 can be accessed and selected via the context2 window tab 30₂.

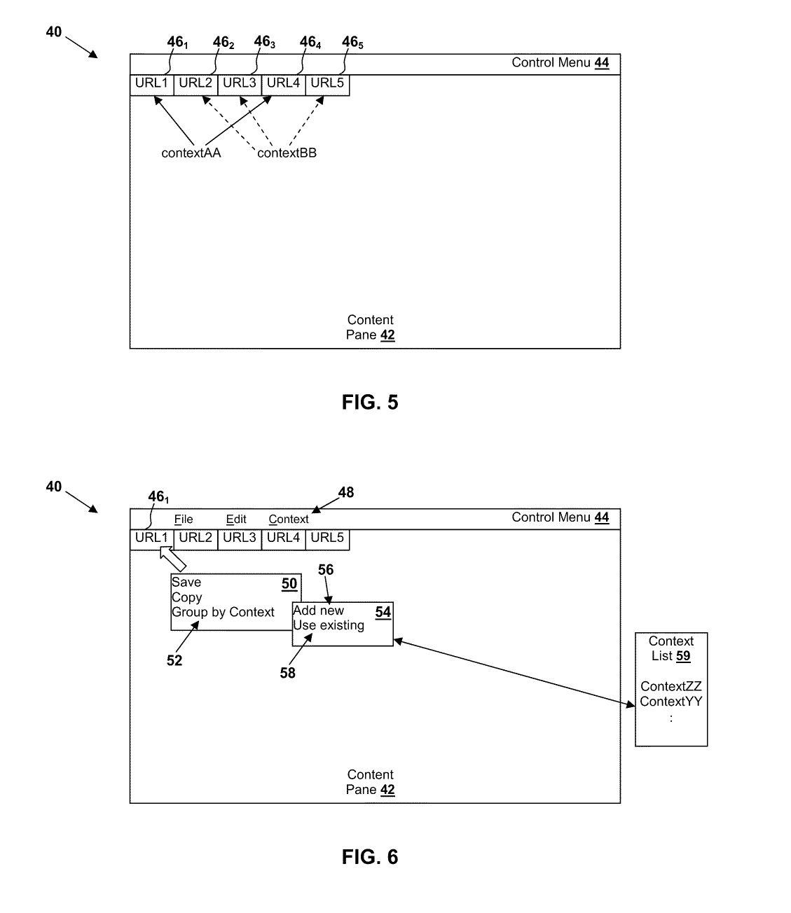

Referring now to FIG. 5, a similar process can be applied in a web browser environment. As shown, the web browser environment comprises a web browser 40 including a content pane 42 for displaying a web page (not shown) associated with an URL (Uniform Resource Locator), and a control menu 44. In this example, the user has performed an internet search for a first context (“contextAA”) and, during the search, has discovered a related context of interest (“contextBB”). To this extent, a plurality of window tabs 46 (46₁-46₅), labeled with the associated URL (URL1-URL5), and which correspond to either contextAA or contextBB, are displayed in the content pane 42. Although now shown for clarity, the web page corresponding to a currently active (e.g., selected, most recently opened, etc.) window tab 46 is displayed in the context pane 42.

Each window tab 46 displays the name of a corresponding URL (URL1-URL5) that has been opened, but does not provide any indication of the context (e.g., contextAA, contextBB) that the user has associated with the URL. As such, to track the context associated with a given URL, the user has to select the window tab 46 corresponding to the URL to display the corresponding web page in the content pane 42.

As depicted in FIG. 6, a user can select the “group by context” function by, for example, right clicking on a selected one of the window tabs 46 (e.g., window tab 46₁ associated with URL1). In response, a contextual menu 50 is displayed to the user. In addition to the functions (if any) typically provided in a contextual menu (e.g., save, copy, cut, paste, etc.), the user is presented with the menu item “group by context” 52. Selection of the “group by context” menu item 52 provides the user with several options, which may be presented in a pop-out window 54 or the like, by which the user can define the context that is to be assigned to a corresponding URL. As shown in FIG. 6, the options may include “add new” 56, which allows the user to define a new context, and “use existing” 58, which allows the user to view and select the context from one or more context lists previously defined by the user. The “group by context” function can also be selected via a menu item 48 (e.g., “Context”) in the control menu 44 (see FIGS. 6-8), via a keyboard shortcut, etc.

An example of a context list 59 containing contexts previously defined by the user is depicted in FIGS. 6-8. The context list 29 is displayed to the user when the “use existing” option 58 is selected, and may, depending upon the embodiment, be displayed to the user when the “add new” option 56 is selected. The context list 59 may also be accessed and displayed at any time via the context menu item 48 in the control menu 44.

In this web browser environment example, the user assigns a new context, namely contextAA, to URL1, using the “add new” option 56. The newly added context (contextAA) is appended to the context list 59 containing contexts previously defined by the user. Once added, the new context (contextAA) is available to the user via the “use existing” context menu option 58.

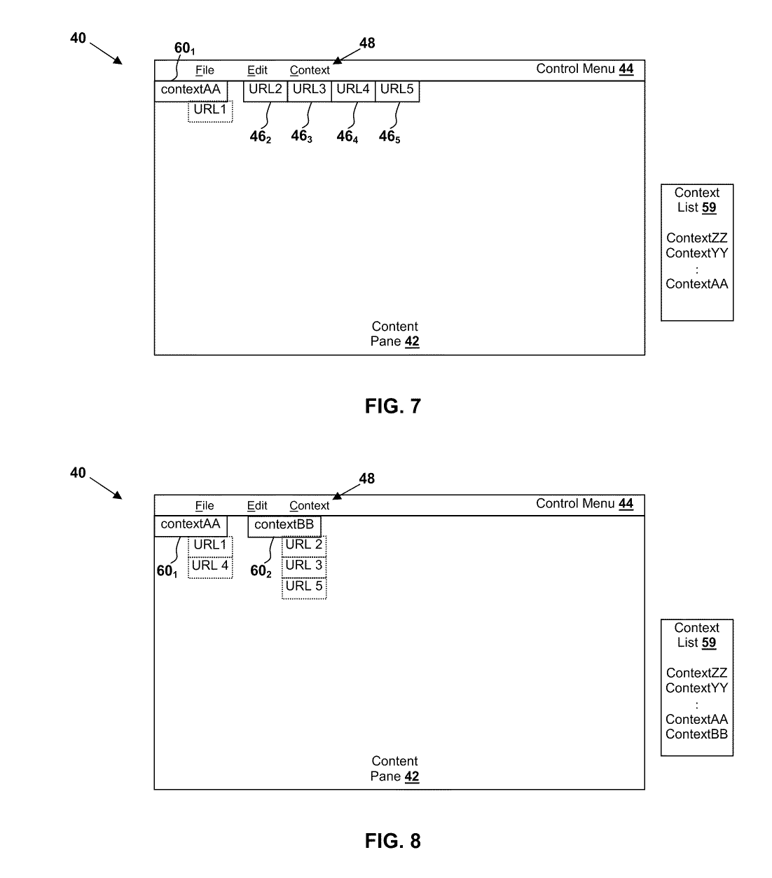

Continuing this example, as shown in FIG. 7, a context window tab 60₁, labeled “contextAA,” is displayed in the content pane 42, while the window tab 46₁ associated with URL1 is no longer displayed. However, as depicted in phantom, URL1 is now associated with the contextAA window tab 60₁. The newly added context (contextAA) is now listed in the context list 59 containing the contexts previously defined by the user.

The user continues the context assignment process by selecting the window tabs 46 associated with the remaining URLs (URL2-URL5), in any desired order, and assigning an existing context (e.g., contextAA) from the context list 59 or a new context (e.g., contextBB) to each of the URLs. As a result, the web browser 40 now appears as shown in FIG. 8, where the context window tabs 60₁, 60₂, labeled “contextAA” and “contextBB,” respectively, are displayed in the content pane 42. At this point, the URLs (URL1, URL4) are associated with the contextAA window tab 60₁, while the URLs (URL2, URL3, URL5) are associated with the contextBB window tab 60₂. The contexts (contextAA, contextBB) are listed in the context list 59 along with any other contexts previously defined by the user.

Each URL may be assigned a plurality of different contexts. For example, if an URL has been assigned to both contextAA and contextBB, the URL will be displayed under both the contextAA window tab 60₁ and the contextBB window tab 60₂ in FIG. 8.

In some environments, it may be possible to select a plurality of the window tabs 46 simultaneously. In such a case, the above process can be used to assign the same new or existing user-defined context to a selected plurality of URLS at the same time.

In an embodiment, the URLs associated with each context window tab 60 are listed from top down in the order in which they were originally opened by the user. Other listing orders are also possible. For example, the URLs can be listed in alphabetical order, in the order in which context was assigned, etc. Further, although the window tabs 46 associated with the URLs are no longer visible in the content pane 42, in another embodiment, the window tabs 46 may be displayed in conjunction with the context window tabs 60. Further, in an embodiment, the listing order of the context window tabs 60 can be changed using, for example, a select and drag operation and/or the like.

The URLs associated with a context window tab 60 can be selectively displayed (e.g., as drop-down tabs, an URL list, etc.) to a user. For example, the URLs associated with a given context window tab 60 can be displayed in response to a user selection of the context window tab 60. A particular URL associated with the selected context window tab 60 can then be selected by the user in order to display the associated web page in the content pane 42. To this extent, as depicted in phantom in FIG. 8, any of the URLs (URL1, URL4) associated with contextAA can be accessed and selected via the contextAA window tab 60₁, while any of the URLs (URL2, URL3, URL5), associated with contextBB can be accessed and selected via the contextBB window tab 60₂.

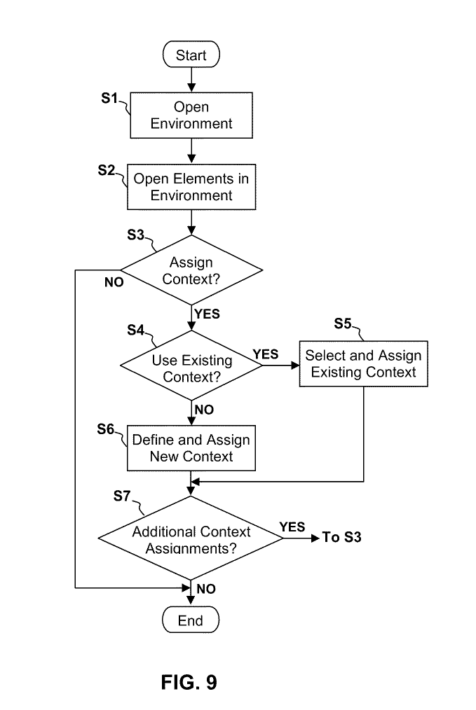

FIG. 9 depicts a flow diagram of a process for using context-based functionality in an environment. As detailed above, the environment may comprise an IDE, a web browser, etc.

At S1, the environment (e.g., IDE, web browser, etc.) is opened. At S2, elements in the environment (e.g., file(s) in an IDE, URL(s) in a web browser, etc.) are opened by a user.

At S3, if the user decides to assign a context to an element in the environment (YES, S3), flow passes to S4. Otherwise (NO, S3), the process ends. At S4, if the user decides to use an existing context (YES, S4), flow passes to S5. If the user decides to define a new context (NO, S4), flow passes to S6. Thereafter, if the user needs to assign a user-defined context to another element (YES, S7), flow passes back to S3. If not (NO, S7), the process ends.

At S5, the user selects and assigns an existing user-defined context to an element. For example, the user may be presented with one or more context lists (see, e.g., context list 29, FIG. 4, context list 59, FIG. 8), each containing one or more existing user-defined contexts. The one or more context lists may comprise a default context list that is associated with the environment in which the user is currently working, and/or other context lists that have been created by the user for different purposes.

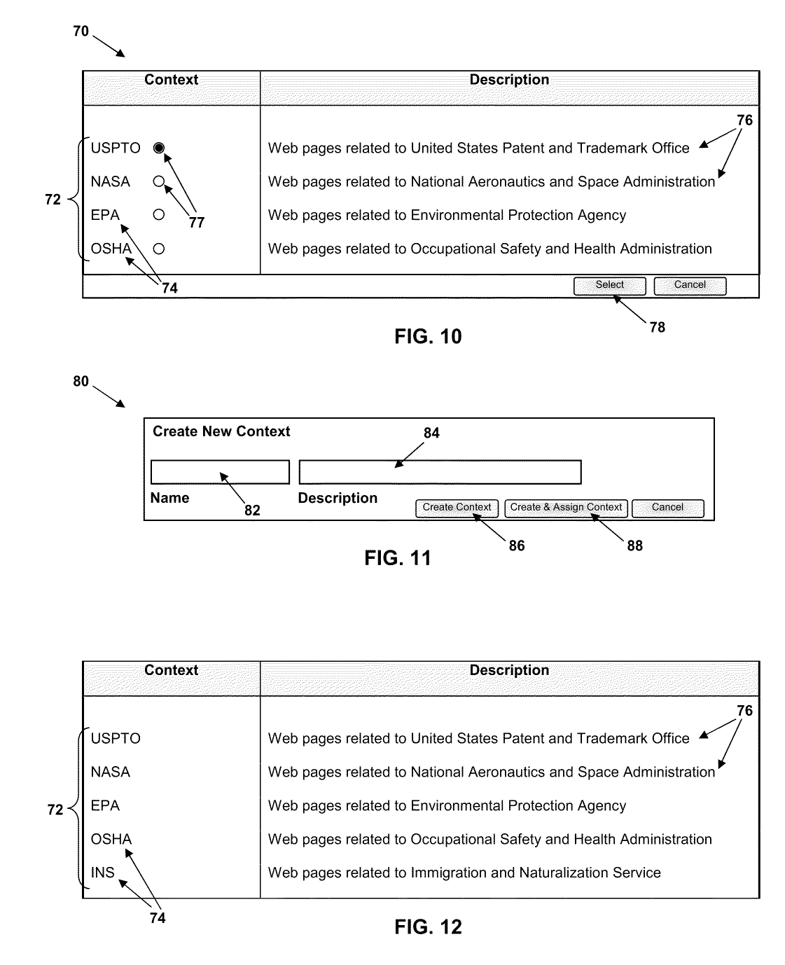

FIG. 10 shows an illustrative “select existing context” dialog box 70. In this example, the “select existing context” dialog box 70 displays a context list 72, which includes a plurality of existing user-defined contexts 74 associated with the web pages of various agencies of the United States government. Each of the contexts 74 has been given a name by the user for identification purposes, and may include a description 76. For example, the user-defined context named “USPTO” corresponds to, and is described as being associated with, web pages related to the United States Patent and Trademark Office. A given context 74 can be selected and assigned to an element by the user, for example, via selection of a corresponding radio button 77 and actuation of a “select” button 78.

Turning back to FIG. 9, at S6, the user defines and assigns a new context to an element. For example, the user may be presented with a “create new context” dialog box 80 for defining the new context. An example of a “create new context” dialog box 80 is shown in FIG. 11. The “create new context” dialog box 80 includes a name field 82 and a description field 84.

By way of example, to create a new context 74 for inclusion in the context list 72 depicted in FIG. 10, the user enters a name (e.g., “INS”) and description (e.g., “Immigration and Naturalization Service”) of the new context 74 in the corresponding name and description fields 82, 84 of the “create new context” dialog box 80. Upon actuating the “create context” button 86 or the “create & assign” button 88, the context list 72 is updated to include the new INS context 74 as illustrated in FIG. 12.

A new context can be defined and added to a context list with or without being concurrently assigned to an element, depending on which button 86, 88 is actuated by the user in the “create new context” dialog box 80. For instance, actuation of the “create context” button 86 results in the creation of a new context, while actuation of the “create & assign” button results in the creation of a new context and the assignment of the new context to an element.

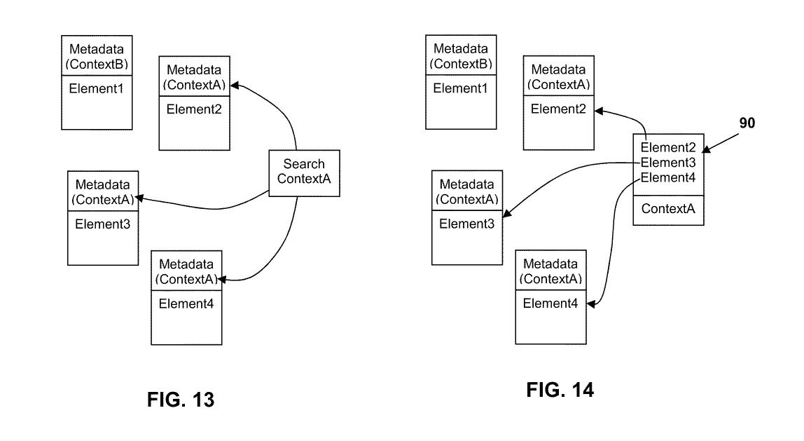

According to an embodiment, metadata can be associated with each element that has been assigned a user-defined context. The metadata may comprise an identifier (e.g., name) of the context, a description of the context, the date/time at which the context was assigned, any previous contexts that may have been assigned, the user that created the context, the user that assigned the context, etc. The metadata can be used to perform a search of elements by context, thereby allowing a user to easily and quickly retrieve a result set of elements associated with a given context. For example, as shown in FIG. 13, a metadata search for the context “contextA” generates a search result set comprising element2, element3, and element4. Element1, which is assigned to contextB, is not a member of the result set. The result set can be displayed to the user via a context window tab or in any other suitable manner.

A user-defined context can include metadata, pointers, links, etc., for identifying the elements that have been assigned to the user-defined context. To this extent, a user can open an existing user-defined context (e.g., via a context menu item, etc.) and determine and/or retrieve the elements that have been assigned to that context. This type of relationship is depicted in FIG. 14, wherein the context “contextA” includes information 90 identifying/locating the elements (element2, element3, element4) that are assigned to contextA. The elements (element2, element3, element4) assigned to contextA can be displayed to the user via a context window tab or in any other suitable manner.

The context menu item in the control menu (see, e.g., context menu item 19, FIG. 4, context menu item 48, FIG. 8) can be used to access various commands for managing user-defined contexts and context lists. The commands can also be accessed via corresponding keyboard shortcuts or in any other suitable manner. The commands provided via the context menu item may be used to create, open, edit, rename, delete, etc., a context list. Further, the commands provided via the context menu item may be used to create, open, edit, rename, delete, etc., the individual contexts within the context list. A command such as “merge” can be provided that allows a user to select and merge a plurality of contexts into a single context. A “publish” command may be provided that allows a user to share one or more contexts and/or context lists with a group of other users.

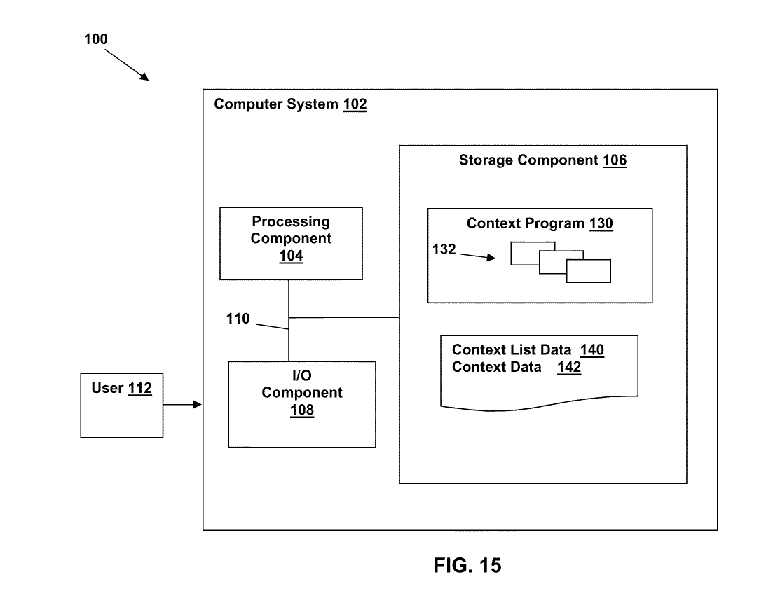

FIG. 15 depicts an illustrative environment 100 for grouping windows based on user-defined contexts according to an embodiment. To this extent, the environment 100 includes a computer system 102 that can perform a process described herein in order to group windows based on user-defined contexts. In particular, the computer system 102 is shown as including a context program 130, which makes computer system 102 operable to group windows based on user-defined contexts by performing any/all of the processes described herein and implementing any/all of the embodiments described herein.

The computer system 102 is shown including a processing component 104 (e.g., one or more processors), a storage component 106 (e.g., a storage hierarchy), an input/output (I/O) component 108 (e.g., one or more I/O interfaces and/or devices), and a communications pathway 110. In general, the processing component 104 executes program code, such as the context program 130, which is at least partially fixed in the storage component 106. While executing program code, the processing component 104 can process data, which can result in reading and/or writing transformed data from/to the storage component 106 and/or the I/O component 108 for further processing. The pathway 110 provides a communications link between each of the components in the computer system 102. The I/O component 108 can comprise one or more human I/O devices, which enable a human user 112 to interact with the computer system 102 and/or one or more communications devices to enable a system user 112 to communicate with the computer system 102 using any type of communications link. To this extent, the context program 130 can manage a set of interfaces (e.g., graphical user interface(s), application program interface, etc.) that enable human and/or system users 112 to interact with the context program 130. Further, the context program 130 can manage (e.g., store, retrieve, create, manipulate, organize, present, etc.) data, such as context lists 140, contexts 142, etc., using any solution.

In any event, the computer system 102 can comprise one or more general purpose computing articles of manufacture (e.g., computing devices) capable of executing program code, such as the context program 130, installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, the context program 130 can be embodied as any combination of system software and/or application software.

Further, the context program 130 can be implemented using a set of modules 132. In this case, a module 132 can enable the computer system 102 to perform a set of tasks used by the context program 130, and can be separately developed and/or implemented apart from other portions of the context program 130. As used herein, the term “component” means any configuration of hardware, with or without software, which implements the functionality described in conjunction therewith using any solution, while the term “module” means program code that enables the computer system 102 to implement the functionality described in conjunction therewith using any solution. When fixed in a storage component 108 of a computer system 102 that includes a processing component 104, a module is a substantial portion of a component that implements the functionality. Regardless, it is understood that two or more components, modules, and/or systems may share some/all of their respective hardware and/or software. Further, it is understood that some of the functionality discussed herein may not be implemented or additional functionality may be included as part of the computer system 102.

When the computer system 102 comprises multiple computing devices, each computing device may have only a portion of context program 130 fixed thereon (e.g., one or more modules 132). However, it is understood that the computer system 102 and context program 130 are only representative of various possible equivalent computer systems that may perform a process described herein. To this extent, in other embodiments, the functionality provided by the computer system 102 and context program 130 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 102 includes multiple computing devices, the computing devices can communicate over any type of communications link. Further, while performing a process described herein, the computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

The computer system 102 can obtain or provide data, such as context lists 140 and contexts 142 using any solution. For example, the computer system 102 can generate and/or be used to generate context lists 140 and contexts 142, retrieve context lists 140 and contexts 142, from one or more data stores, receive context lists 140 and contexts 142, from another system, send context lists 140 and contexts 142 to another system, etc.

While shown and described herein as a method and system for grouping windows based on user-defined contexts, it is understood that aspects of the invention further provide various alternative embodiments. For example, in one embodiment, the invention provides a computer program fixed in at least one computer-readable medium, which when executed, enables a computer system to group windows based on user-defined contexts. To this extent, the computer-readable medium includes program code, such as the context program 130 (FIG. 15), which implements some or all of the processes and/or embodiments described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; etc.

In another embodiment, the invention provides a method of providing a copy of program code, such as the context program 130 (FIG. 15), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for grouping windows based on user-defined contexts. In this case, a computer system, such as the computer system 102 (FIG. 15), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; etc.

It is understood that aspects of the invention can be implemented as part of a business method that performs a process described herein on a subscription, advertising, and/or fee basis. That is, a service provider could offer to group windows based on user-defined contexts as described herein. In this case, the service provider can manage (e.g., create, maintain, support, etc.) a computer system, such as the computer system 102 (FIG. 15), that performs a process described herein for one or more customers. In return, the service provider can receive payment from the customer(s) under a subscription and/or fee agreement, receive payment from the sale of advertising to one or more third parties, and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A computer-implemented method of grouping windows based on user-defined contexts, the method comprising:
assigning a user-defined context to a plurality of elements in an environment;
grouping the plurality of elements into at least one group based on the user-defined context assigned to each of the plurality of elements; and
displaying a context window tab corresponding to each group of elements.

2. The method of claim 1, further comprising:
accessing a group of elements by selecting the context window tab corresponding to the group of elements.

3. The method of claim 1, wherein the assigning of a user-defined context further comprises:
creating, by a user, a new user-defined context;
adding the new user-defined context to a context list; and
assigning the new user-defined context to an element.

4. The method of claim 1, wherein the assigning of a user-defined context further comprises:
accessing a context list containing at least one existing user-defined context previously defined by a user; and
assigning a user-defined context from the context list to an element.

5. The method of claim 1, wherein the environment is selected from the group consisting of an Integrated Development Environment (IDE) and a web browser.

6. The method of claim 1, wherein the element is selected from the group consisting of a file and a Uniform Resource Locator (URL).

7. The method of claim 1, further comprising:
obtaining a context list containing a plurality of user-defined contexts; and
managing the user-defined contexts in the context list.

8. A computer system comprising:
a component configured to group windows based on user-defined contexts by:
assigning a user-defined context to a plurality of elements in an environment;
grouping the plurality of elements into at least one group based on the user-defined context assigned to each of the plurality of elements; and
displaying a context window tab corresponding to each group of elements.

9. The computer system of claim 8, wherein the component is further configured to group windows based on user-defined contexts by:
accessing a group of elements by selecting the context window tab corresponding to the group of elements.

10. The computer system of claim 8, wherein the assigning of a user-defined context further comprises:
creating, by a user, a new user-defined context;
adding the new user-defined context to a context list; and
assigning the new user-defined context to an element.

11. The computer system of claim 8, wherein the assigning of a user-defined context further comprises:
accessing a context list containing at least one existing user-defined context previously defined by a user; and
assigning a user-defined context from the context list to an element.

12. The computer system of claim 8, wherein the environment is selected from the group consisting of an Integrated Development Environment (IDE) and a web browser, and wherein the element is selected from the group consisting of a file and a Uniform Resource Locator (URL), respectively.

13. The computer system of claim 8, wherein the component is further configured to group windows based on user-defined contexts by:
obtaining a context list containing a plurality of user-defined contexts; and
managing the user-defined contexts in the context list.

14. A computer program comprising program code embodied in at least one computer-readable medium, which when executed, enables a computer system to implement a method of grouping windows based on user-defined contexts, the method comprising:
assigning a user-defined context to a plurality of elements in an environment;
grouping the plurality of elements into at least one group based on the user-defined context assigned to each of the plurality of elements; and
displaying a context window tab corresponding to each group of elements.

15. The computer program of claim 14, wherein the method further comprises:
accessing a group of elements by selecting the context window tab corresponding to the group of elements.

16. The computer program of claim 14, wherein the assigning of a user-defined context further comprises:
creating, by a user, a new user-defined context;
adding the new user-defined context to a context list; and
assigning the new user-defined context to an element.

17. The computer program of claim 14, wherein the assigning of a user-defined context further comprises:
accessing a context list containing at least one existing user-defined context previously defined by a user; and
assigning a user-defined context from the context list to an element.

18. The computer program of claim 14, wherein the environment is selected from the group consisting of an Integrated Development Environment (IDE) and a web browser.

19. The computer program of claim 14, wherein the element is selected from the group consisting of a file and a Uniform Resource Locator (URL).

20. The computer program of claim 14, wherein the method further comprises:
obtaining a context list containing a plurality of user-defined contexts; and
managing the user-defined contexts in the context list.
